(19) United States
(12) Patent Application Publication
(10) Pub. No.: US 2007/0071036 A1
(43) Pub. Date: Mar. 29, 2007

(54) Method and apparatus for preamble synchronization in wireless radio frequency identification (RFID) systems

(75) Inventors: Yuri Okunev, Middle Island, NY (US); Valery Maizenberg, Danbury, CT (US)

Correspondence Address: STERNE, KESSLER, GOLDSTEIN & FOX PLLC, 1100 NEW YORK AVENUE, N.W., WASHINGTON, DC, 20005, US

(73) Assignee: Symbol Technologies, Inc., Holtsville, NY (US)

(21) Appl. No.: 11/234,417

(22) Filed: Sep. 26, 2005

(51) Int. Cl. H04J 3/06

(52) U.S. Cl. 370/503

(57) ABSTRACT

The present invention provides methods and apparatuses for detection of a preamble portion of a data packet. A plurality of samples are received in an input signal. Samples that occur between consecutive sign changes in the received plurality of samples are counted. The counting of samples is performed a number of times to produce a sequence of counts of samples between consecutive sign changes in the received plurality of samples. Matched filtering of the sequence of counts of samples is performed to determine whether a preamble is detected. Bit rate and timing are initialized for data decoding based on parameters of the sequence of sample counts of a detected preamble.

### BACKGROUND OF THE INVENTION

1. Field of the Invention

The present invention relates to wireless communications, and more particularly, to radio frequency identification (RFID) communication systems, including readers that demodulate and decode signals received from RFID tags.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

With the maturation of RFID technology, efficient communication between tags and interrogators has become a key enabler in supply chain management, especially in manufacturing, shipping, and retail industries, as well as in building security installations, healthcare facilities, libraries, airports, warehouses etc.

In a RFID system, an interrogator transmits a continuous wave (CW) or modulated radio frequency (RF) signal to a tag. The tag receives the signal, and responds by modulating the signal, “backscattering” an information signal to the interrogator. The interrogator receives signals back from the tag, and the signals are demodulated, decoded and further processed.

Development of reliable demodulation and decoding procedures for encoded backscattered signals is an important goal for wireless system design, including wireless RFID systems. A RFID communication channel is usually plagued with severe interference, multipath propagation, and fast fading, especially when a tag or/and a reader are moving. Additionally, the tag backscatter signal has considerable variation in its parameters. A tag backscatter signal can have random delay, amplitude, frequency and phase, which are rapidly changing functions of time.

A recent RFID standard specifies communication parameters for a 2^{nd} generation of RFID systems, known as “Gen2 RFID systems” with extended data transmission capabilities, including different modulation and encoding techniques, and a wide spectrum of bit rates. The high speed transmission of data according to Gen2 requires more sophisticated signal processing procedures which provide high performance in terms of bit error rate (BER) and block error rate (BLER), in as simple an implementation of both tags and readers as possible.

An important part of reliable signal processing is the detection of a preamble portion of a signal packet. In wireless systems, a preamble is used in the initial stages of data processing of a signal packet. Typically, the initial stages include the measurement (estimation) of signal parameters, such as amplitude, frequency, phase, symbol duration, signal power, and signal-to-noise ratio (SNR), and initial timing (symbol synchronization). The preamble is especially important for the proper operation of RFID systems because a RFID data session usually includes a very short (time limited) bit package. Therefore, any failure in correctly detecting the preamble decreases the probability of correctly decoding the received data, including causing increased BLER.

Thus, efficient signal processing procedures are needed for detecting the preamble portion of signal packets, such as in RFID systems. The efficient signal processing procedures should provide for high performance with relatively simple implementation.

### BRIEF SUMMARY OF THE INVENTION

Methods, systems, and apparatuses for operation and implementation of RFID reader interrogators capable of detecting, demodulating and/or decoding encoded backscattered signals from RFID tags are described.

Efficient signal processing procedures are described for detecting the preamble portion of signal packets, such as in RFID systems, which provide for high performance in relatively simple implementations.

In aspects of the present invention, methods and systems for detecting a preamble portion of a signal are provided. A preamble is typically an initial portion of a data packet, which is followed by the actual data of the data packet. Detecting the preamble portion of the data packet enables the recovery of data from the remainder of the data packet.

In an example aspect of the present invention, a plurality of samples are received in an input signal. Samples that occur between consecutive sign changes in the received plurality of samples are counted. “Z” is a number of sign changes expected to occur when actually receiving a preamble. The counting of samples is performed a number Z (or fewer) times to produce a sequence of Z (or less than Z) counts of samples between consecutive sign changes in the received plurality of samples. Matched filtering of the sequence of Z (or less than Z) counts of samples is performed to determine whether a preamble is detected.

According to aspects of the present invention, various preamble types can be detected using their respective properties, including a known number of sign changes occuring in the preamble, and known lengths of time (time intervals) occurring between the sign changes.

If a preamble is not initially detected, an additional count of samples between the previous sign change and a next sign change in the received plurality of samples can be performed. Matched filtering can then be performed using the additional count of samples and the previous Z-1 counts of samples. The sample counting and matched filtering can be repeated until a preamble is successfully detected.

In an example aspect, sample counting and matched filtering is performed in both channels of an I/Q system. In other words, in a first channel, sample counting and matched filtering can be performed on an in-phase signal component of an input signal, and in a second channel, sample counting and matched filtering can be performed on a quadrature-phase signal component of the input signal. A preamble may be detected by one or both channels. The preamble detection results of the two channels can be used separately or combined, if desired.

For example, in an aspect, if a preamble is detected by both channels, it can be determined which of the in-phase and quadrature-phase signal components has a higher signal level (or other feature). The in-phase signal component or the quadrature-phase signal component having the higher signal level can be further used to determine the bit rate and timing for subsequent data processing, such as data decoding.

In a further aspect, if a preamble is detected, an estimate of a data rate and of a timing of the input data can be determined.

In a still further aspect, if a preamble is detected, a start of data can be indicated at a first sample following the detected preamble.

These and other aspects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with each other as well as with an exemplary population of RFID tags, according to an embodiment of the present invention.

FIG. 2A shown a block diagram of the receiver portion of a RFID reader interrogator, according to an example of the present invention.

FIG. 2B shown a block diagram of a conventional receiver portion of a RFID reader interrogator.

FIGS. 3A and 3B show various sequences of a FM0 encoded signal that is transmitted from a RFID tag to a RFID reader interrogator.

FIGS. 3C and 3D show preambles for FM0 encoded data signals.

FIGS. 4A, 4B, and 4C show various subcarrier sequences of a Miller encoded signal that are transmitted from a RFID tag to a RFID reader interrogator.

FIGS. 4D-4I show preambles for Miller encoded data signals

FIG. 5 shows a flowchart for detecting a preamble, according to an example embodiment of the present invention.

FIG. 6 shows example sampling of a preamble of an information packet, according to an embodiment of the present invention.

FIG. 7 shows an example flow diagram for detecting a preamble for in-phase and quadrature phase components of an input signal, according to an embodiment of the present invention.

FIG. 8 shows an example block diagram of a matched filter, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present invention relates to wireless telecommunications apparatus, systems and methods which implement data transmission via radio channels with variable parameters. For example, embodiments of the present invention relate to radio frequency identification (RFID) reader interrogators, which provide for detection, demodulation and decoding of signals from tags.

Although described below with respect to RFID communications systems, it will be apparent to persons skilled in the relevant art(s) that other types of communications systems are also within the scope and spirit of the present invention.

Interaction between tags and reader interrogators takes place according to one or more RFID communication protocols, such as those approved by the RFID standards organization EPCglobal (EPC stands for Electronic Product Code). One example of a communication protocol is the widely accepted emerging EPC protocol, known as Generation-2 Ultra High Frequency RFID (“Gen 2”). Gen 2 allows a number of different tag “states” to be commanded by reader interrogators. A detailed description of the EPC Gen 2 protocol may be found in “EPC™ Radio-Frequency Identity Protocols Class-1 Generation-2 UHF RFID Protocol for Communications at 860 MHz-960 MHz,” Version 1.0.7 (“EPC Gen 2 Specification”), and published 2004, which is incorporated by reference herein in its entirety.

A reader transmits a signal to a tag population. Once a reader interrogator receives a modulated response signal back from a RFID tag, the reader performs a considerable amount of data processing to demodulate and decode the received signal.

Some conventional approaches to data processing and preamble detecting are based on a correlation method. The correlation method involves computation of the correlation coefficients between a received signal and one or more a priori known reference signals. The reference signals comprise coherent or non-coherent replicas of the variants of the received signal. For preamble detecting, the received signal and reference signal(s) are shifted in time with respect to each other, searching for a maximum correlation between them

There are disadvantages to the correlation approach used in existing RFID systems. An example disadvantage is related to an uncertainty in the accuracy of the reference signals in the receiver portion, caused by unpredictable and considerable variation in the subcarrier frequency. Such variation may result from a cycle period offset present in the tag transmitter. According to the Gen 2 specification, this variation can be equal to 15% of the cycle period. For example, if a nominal number of samples in a cycle period is equal to 64, the actual number of samples during the cycle period can range from 54 to 74. With this condition, the correlation method is decreased in accuracy (compared to the perfect reference), particularly in a multipath, noisy RF environment.

Under such conditions, the correlation approach requires utilization of several reference sequences with the same waveforms, but having different symbol intervals (i.e., different numbers of samples within the variable symbol interval). Thus, the correlation approach requires optimization of the following two variables: (a) a number of samples within reference signal, and (b) a shift between the received signal and reference signals. For example, the nominal number of samples in a reference waveform may be equal to 64, with the actual number of samples during the cycle period ranging from 54 to 74. To span the cycle period range from 54 to 74, a number of reference signals available for correlation could be selected to be 11. The number of samples N for each of the 11 reference signals can be set as follows: N₁=54, N₂=56, . . . , N₁₁=74, where the number of samples is incremented by 2 from one reference signal to the next.

Such a “multiple reference” correlation procedure decreases synchronization accuracy as compared to a single reference correlation procedure in a real multipath, noisy RF environment. Furthermore, the correlation algorithm requires a high level of complexity in a real RFID environment, and does not provide desired reliability in preamble synchronization. The correlation method involves multiplication of received signal and reference samples, saving reference samples, and adaptive adjustment of reference parameters.

The present invention provides methods and apparatuses for demodulation and decoding of backscattered tag signals, represented by their in-phase and quadrature components in the receiver portion of a reader interrogator. In particular, methods and systems are described for the synchronization of the preambles of tag signals received by a reader. It is noted that the receiver portion of the reader interrogator is often referred to as “reader receiver” in the present application. Additionally, please note that the in-phase and quadrature components of a-received encoded signal are in quadrature phase (i.e., 90°) with respect to each other. Thus, both are referred as quadrature components of the received signal. For sake of differentiation and clarity, we have labeled and described one of the components as an in-phase component (I), and the other component as a quadrature component (Q).

The methods and systems described in the present application have several advantages compared to the conventional correlation method. The method provides stable performance and reliable decision making even with considerable variation of backscattered signal parameters. Reference signals are not used. Complex correlation processing is not required, and instead, simple computations of numbers of samples and comparison of these numbers with thresholds are performed.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Example RFID System Embodiment

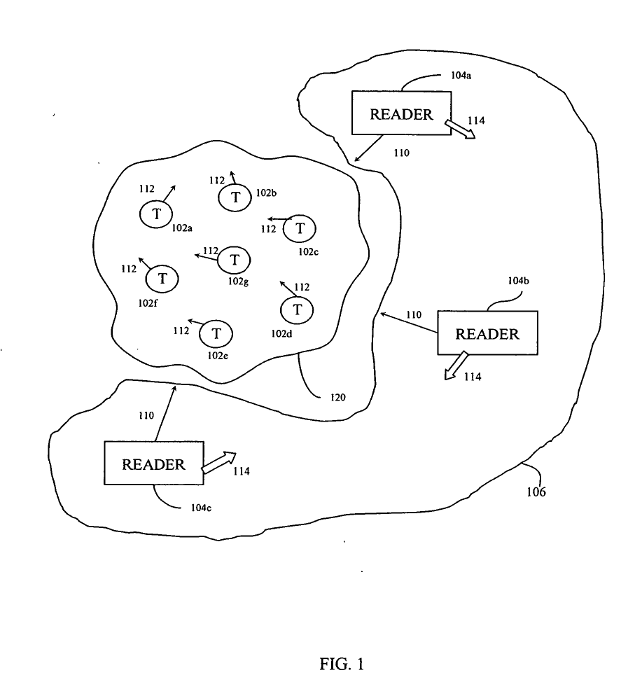

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. According to embodiments of the present invention, a population 120 may include any number of tags 102.

Environment 100 includes either a single reader 104 or a plurality of readers 104, such as readers 104a-104c. In an embodiment, a reader 104 may be requested by an external application to address the population of tags 120. Alternatively, reader 104 may have internal logic that initiates communication, or may have a trigger mechanism that an operator of reader 104a uses to initiate communication.

As shown in FIG. 1, readers 104 transmit an interrogation signal 110 having a carrier frequency to the population of tags 120. Readers 104 operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102.

In addition to being capable of communicating with tags 102, readers 104a-104c may communicate among themselves in a reader network 106. Each of readers 104a-104c transmits reader signals 114 to others of readers 104a-104c, and receives reader signals 114 from others of readers 104a-104c.

The present invention works in an environment (with reference to FIG. 1) where reader-to-tag, tag-to-reader, and reader-to-reader communication is allowed. Specifically, the present invention refers to the tag-to-reader communication, and the subsequent signal processing performed in the receiver portion of the reader.

Example Conventional RFID Reader Embodiment

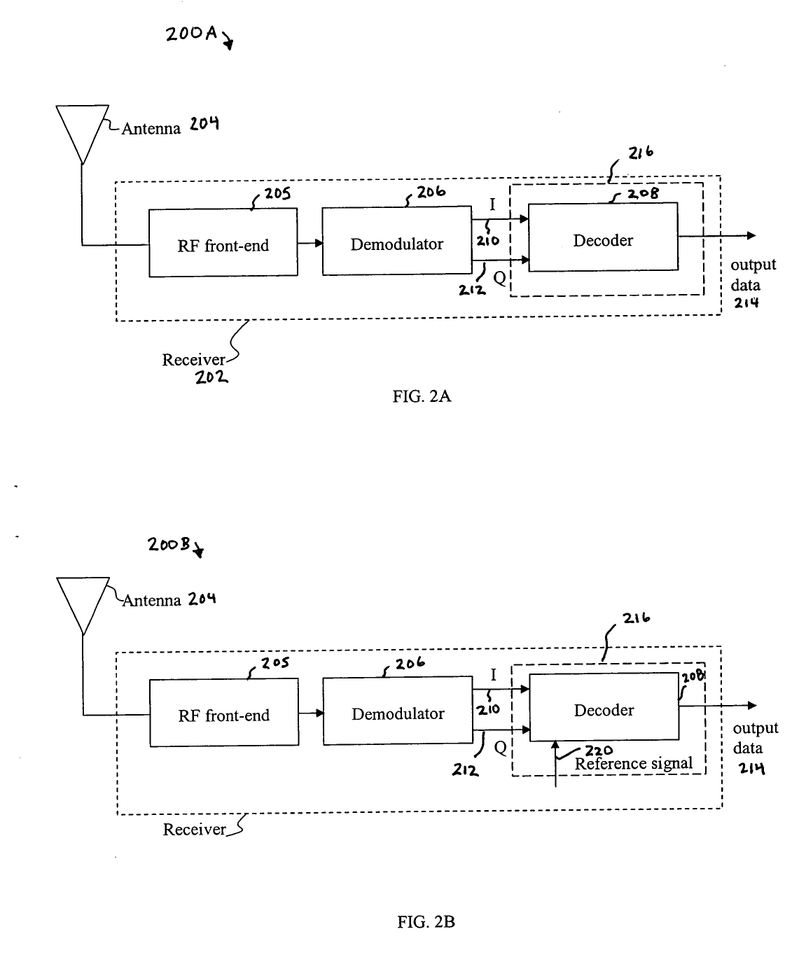

FIG. 2A shows an example block diagram of the receiver portion of a conventional RFID reader 200A. Reader 200A typically includes one or more antennas 204, one or more receivers 202, one or more transmitters, one or more memory units, and one or more processors (transmitters, memory units, and processors are not shown in FIG. 2A). As shown in the example of FIG. 2A, receiver 202 includes a RF front-end 205, a demodulator 206, and a decoder 208. These components of reader 200A may include software, hardware, and/or firmware, or any combination thereof, for performing their functions, which are described in further detail in subsequent sections herein.

Reader 200A has at least one antenna 204 for communicating with tags 102 and/or other readers 104. In an example FCC environment, interrogator transmission and tag responses are spectrally separated. A tag response signal includes data modulated according to an amplitude shift keying (ASK), phase shift keying (PSK), or other modulation format.

RF front-end 205 typically includes one or more of antenna matching elements, amplifiers, filters, an echo-cancellation unit, and/or a down-converter. In an embodiment, RF front-end 205 receives the tag response signal through antenna 204 and down-converts the response signal to a frequency range amenable to further signal processing.

Demodulator 206 is coupled to an output of RF front-end 205, and receives the modulated and frequency down-converted tag response signal from RF front-end 205. Demodulator 206 is demodulates the down-converted tag response signal. At the output of demodulator 206, the tag response signal is represented by an in-phase component 210 (denoted as I), and a quadrature-phase component 212 (denoted as Q). In an alternative embodiment for demodulator 206, quadrature-phase component 212 is not necessary, and is thus not output.

Decoder 208 is coupled to an output of demodulator 206 and receives in-phase and quadrature components 210 and 212, respectively. Gen 2 tag response signals encode backscattered data as either FM0 baseband or Miller modulation of a subcarrier at the data rate. The reader interrogator commands the encoding choice. Different sub-components included within decoder 208 are further described below with reference to subsequent figures. Decoder 208 executes one or more algorithms in order to generate decoded data signal 214. In an alternative embodiments for decoder 208, decoder 208 decodes a single input signal.

Signal components 210 and 212 along with decoder 208 comprise the base-band portion 216 of receiver 202. Example embodiments for base-band portion 216 are described in further detail below.

FIG. 2B shows another reader interrogator 200B similar to reader interrogator 200A (shown in FIG. 2A) with one or more additional input reference signals 220 in base-band portion 216 of the reader receiver. Signal 220 is an a priori known reference signal. As mentioned before, conventional reader receivers generate and save reference signal(s) 220, adaptively adjust reference signal parameters, and multiply backscattered tag signal and reference signal(s) in order to calculate correlation coefficients. These steps necessitate complicated decoder device capable of high speed digital signal processing (DSP). As will be discussed later, embodiments of the present invention do not require reference signal(s) 220 for preamble detection and estimation (although in embodiments, reference signals may be used during data decoding), making the device implementation and signal processing operation much simpler.

Example RFID Data Encoding Techniques

FM0 baseband and Miller modulation of a subcarrier are two commonly used data encoding techniques used in backscattered signals received by an RFID reader interrogator from a RFID tag. Further encoding techniques are also within the scope and spirit of the present invention. Example relevant details of FM0 and Miller encoding techniques are described below. Further details of FM0 and Miller encoding can be found in the EPC Gen 2 Specification referenced above.

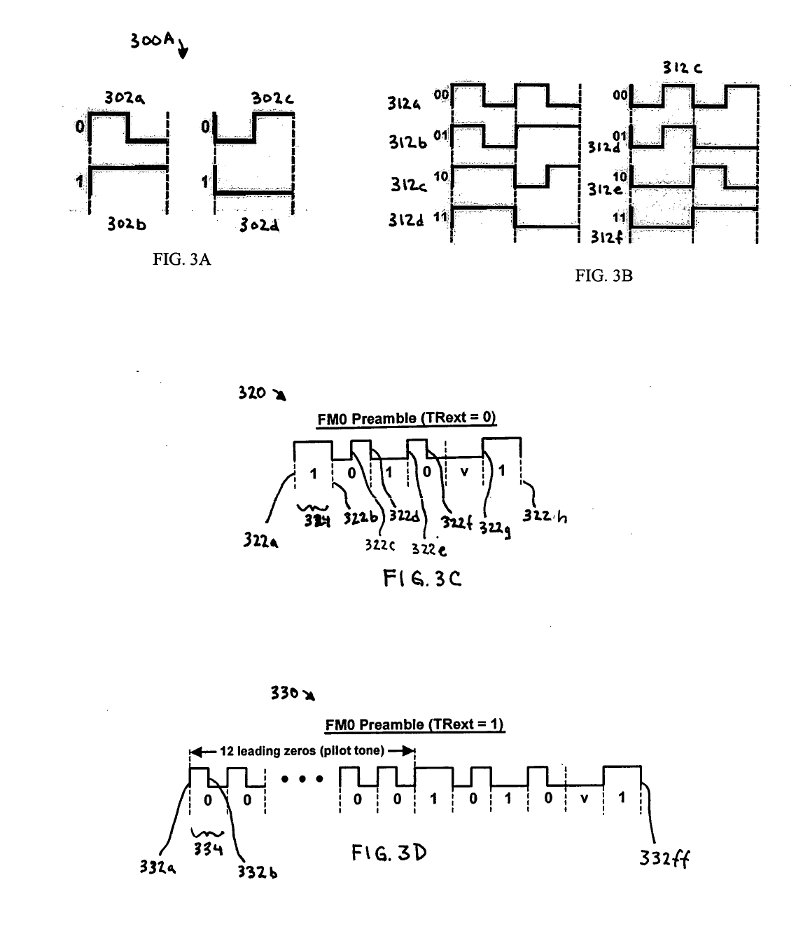

FIGS. 3A and 3B illustrate characteristics of FM0 encoded data. FM0 encoding is also known as bi-phase space encoding. FM0 inverts the baseband phase at every symbol boundary. Additionally, a data symbol representing ‘0’, also known as data-0, undergoes a mid-symbol phase inversion. A data symbol representing ‘1’, also known as data-1, does not undergo this additional mid-symbol phase inversion. Data-0 symbols 302a and 302c are two possible representations of a data ‘0’ in FM0 encoded symbols. Data-1 symbols 302b and 302d are two possible representations of a data ‘1’ in FM0 encoded symbols.

FIG. 3B shows example FM0 sequences generated by arranging FM0 symbols depicted in FIG. 3A. Sequences 312a and 312e are “00” data sequences, sequences 312b and 312f are “01” data sequences, sequences 312c and 312g are “10” data sequences, and sequences 312d and 312h are “11” data sequences. For example, sequence 312c is generated by concatenating a data-1 symbol 302b and a data-0 symbol 302c. As shown in FIG. 3B, there is a phase inversion in each sequence at the boundary between symbols, as indicated at the center vertical dotted line through each of sequences 312a-312h.

FM0 signaling, from a tag to a reader, begins with one of the two preambles 320 and 330 shown in FIGS. 3C and 3D, respectively. The choice whether preamble 320 or 330 is used in a tag response depends on the value of the “TRext” bit specified in the “Query” command from the reader that initiated the inventory round. As shown in FIG. 3C, preamble 320 is used when the TRext bit is equal to “0”. Preamble 320 has a length of six bit or symbol intervals 324. Furthermore, preamble 320 begins at a time point 322a, and includes seven sign changes at time points 322b-h that follow time point 322a.

As shown in FIG. 3D, preamble 330 is used when the TRext bit is equal to “1”. Preamble 330 has a length of eighteen bit or symbol intervals 334. Furthermore, preamble 330 begins at a time point 332a, and includes 31 sign changes at time points 332b-ff that follow time point 332a.

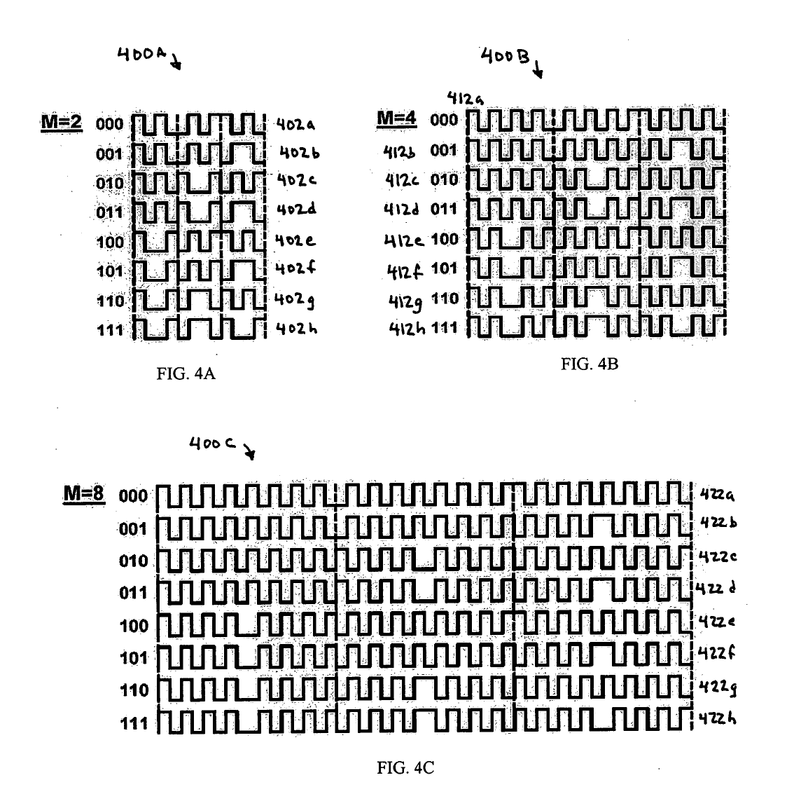

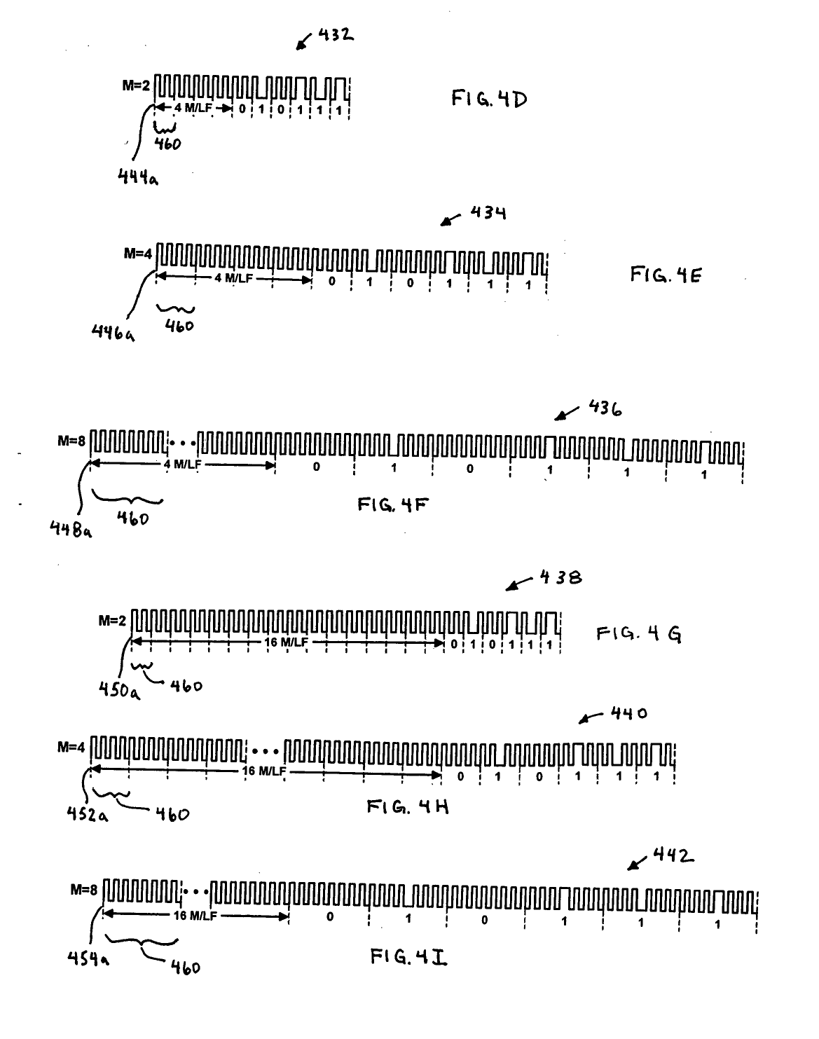

FIGS. 4A, 4B, and 4C illustrate characteristics of Miller encoded data. A baseband Miller encoder inverts phase between two data-0s in sequence. The baseband Miller encoder also places a phase inversion in the middle of a data-1 symbol. FIGS. 4A-4C show Miller-modulated subcarrier sequences. FIG. 4A shows sequences, 402a-402h. FIG. 4B shows sequences 412a-412h. FIG. 4C shows sequences 422a-422h. A Miller sequence contains exactly two, four, or eight subcarrier cycles per bit, depending on an “M” value specified in the command initiated by the reader interrogator. FIG. 4A shows Miller subcarrier sequences corresponding to M=2, FIG. 4B shows Miller subcarrier sequences corresponding to M=4, and FIG. 4C shows Miller subcarrier sequences corresponding to M=8.

Miller subcarrier signaling, from a tag to a reader, begins with one of preambles 432-442 shown in FIGS. 4D-4I. The choice of preambles 432-442 depends on the value of the TRext bit specified in the Query command from the reader that initiated the inventory round, and the value of “M”. Preambles 432, 434, and 436 can be used when the TRext bit is equal to “0”, while preambles 438, 440, and 442 can be used when the TRext bit is equal to “1.”As shown in FIG. 4D, preamble 432 has a length of ten bit or symbol intervals 460. Furthermore, preamble 432 contains 2 subcarrier cycles per bit (M=2), begins at a time point 444a, and includes 36 sign changes at time points subsequent to time point 444a.

As shown in FIG. 4E, preamble 434 has a length of ten bit or symbol intervals 460. Furthermore, preamble 434 contains 4 subcarrier cycles per bit (M=4), begins at a time point 446a, and includes 76 sign changes at time points subsequent to time point 446a.

As shown in FIG. 4F, preamble 436 has a length of ten bit or symbol intervals 460. Furthermore, preamble 436 contains 8 subcarrier cycles per bit (M=8), begins at a time point 448a, and includes 156 sign changes at time points subsequent to time point 448a.

As shown in FIG. 4G, preamble 438 has a length of twenty-two bit or symbol intervals 460. Furthermore, preamble 438 contains 2 subcarrier cycles per bit (M=2), begins at a time point 450a, and includes 84 sign changes at time points subsequent to time point 450a.

As shown in FIG. 4H, preamble 440 has a length of twenty-two bit or symbol intervals 460. Furthermore, preamble 440 contains 4 subcarrier cycles per bit (M=4), begins at a time point 452a, and includes 172 sign changes at time points subsequent to time point 452a.

As shown in FIG. 41, preamble 442 has a length of twenty-two bit or symbol intervals 460. Furthermore, preamble 442 contains 8 subcarrier cycles per bit (M=8), begins at a time point 454a, and includes 348 sign changes at time points subsequent to time point 454a.

Example Embodiment of Preamble Decoding

Embodiments of the present invention are applicable to Gen2 RFID modulation and encoding modes including ASK and PSK modulation, and FM0 and Miller encoding, and are adaptable to further RFID protocol, modulation schemes, and encoding methods, as would be understood by persons skilled in the relevant art(s) by the teachings herein.

It is assumed that a RFID receiver provides conventional linear transformation of the received high-frequency signal to the base-band components I and Q of the modulated carrier, such as according to the example configuration of receiver 202 shown in FIG. 2A. As mentioned previously, I and Q are in quadrature with respect to each other. The in-phase component may be described herein as I, and the quadrature-phase component may be described herein as Q. Additionally, it is assumed that signal components I and Q, presented by their samples, do not contain a constant (DC) component in them. However, embodiments of the present invention are adaptable to I and Q containing a DC component, as would be understood by persons skilled in the relevant art(s) from the teachings herein.

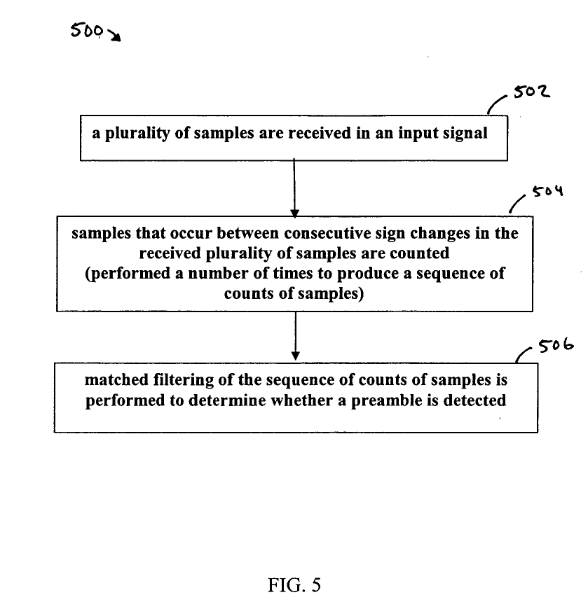

FIG. 5 shows a flowchart 500 providing example steps for detecting a preamble portion of a signal, according to an embodiment of the present invention. The steps of flowchart 500 can be performed by embodiments of readers described herein, for example. Other structural and operational embodiments will be apparent to persons skilled in the relevant art(s) based on the following discussion related to flowchart 500. The steps shown in FIG. 5 do not necessarily have to occur in the order shown.

Flowchart 500 begins with step 502. In step 502, a plurality of samples are received in an input signal. For example, the input signal is a signal received from a tag that is responding to a reader interrogation. The input signal may be demodulated to a baseband signal by a demodulator. The plurality of samples, therefore, may be a series of analog or digital samples output by the demodulator, representing the baseband signal.

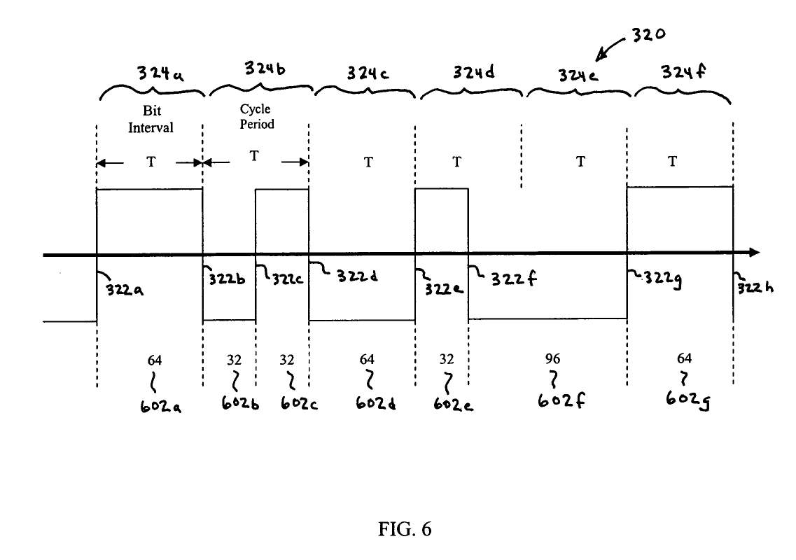

In step 504, samples that occur between consecutive sign changes in the received plurality of samples are counted. For example, FIG. 6 shows an expanded view of preamble 320 of FIG. 3C. As described above preamble 320 is a FM0 preamble (TRext=0). Preamble 320 has a length of six bit or symbol intervals 324a-324f. Furthermore, preamble 320 begins at a time point 322a, and includes seven sign changes at time points 322b-h that follow time point 322a. Assuming that preamble 320 is being received on the input signal, a first sample count 602a is generated between time points 322a and 322b, as samples are received on the input signal between time points 322a and 322b. For example, a processor, counter, or any other suitable logic/circuitry may be used to perform step 504.

Step 504 is performed multiple times to create a plurality of sample counts that can be processed (e.g., matched filtered) to determine whether a preamble is received. In a typical system, step 504 is repeated continuously, at least during a period during which a preamble is expected to be received. In an embodiment, “Z” is a predetermined number of sign changes (e.g., zero crossings) expected for a particular preamble type. Thus, in an embodiment, “Z” sample counts generated by performing step 504 “Z” times (e.g., the last “Z” sample counts obtained when performing step 504 continuously) can be processed to determine whether an entire preamble is received. In another embodiment, fewer than “Z” sample counts are processed to determine whether a portion of a preamble is received. For example, in such an embodiment, the preamble is assumed to be detected when merely a portion of the preamble detected. Thus, in an embodiment, a sequence of “N” sample counts can be obtained by performing step 504 N times, where N is equal to or less than Z.

For example, step 504 may be performed seven times for a FM0 preamble (TRext=0), because seven sign changes are expected for this preamble type (i.e, Z=7 for a FM0, TRext=0 preamble). Thus, a sequence of seven sample counts 602a-602g are generated between consecutive sign changes in the received plurality of samples. In the current example, in addition to sample count 602a, a sample count 602b is a count of samples between sign changes at time points 322b and 322c, a sample count 602c is a count of samples between sign changes at time points 322c and 322d, a sample count 602d is a count of samples between sign changes at time points 322d and 322e, a sample count 602e is a count of samples between sign changes at time points 322e and 322f, a sample count 602f is a count of samples between sign changes at time points 322f and 322g, and a sample count 602g is a count of samples between sign changes at time points 322g and 322h.

As described above, different preamble types have different numbers Z of expected sign changes. Table 1 below shows expected sign changes for some example preamble types.

TABLE 1

| Preamble Type | Number Z of sign changes expected |
|---|---|
| FM0 (TRext = 0) | 7 |
| FM0 (TRext = 1) | 31 |
| Miller (TRext = 0, M = 2) | 36 |
| Miller (TRext = 0, M = 4) | 76 |
| Miller (TRext = 0, M = 8) | 156 |
| Miller (TRext = 1, M = 2) | 84 |
| Miller (TRext = 1, M = 4) | 172 |
| Miller (TRext = 1, M = 8) | 348 |

Although embodiments are described herein with respect to the seven expected sign changes of the FM0 (TRext=0) preamble, it will be understood by persons skilled in the relevant art(s) how to adapt embodiments to these other preamble types, and to further preamble types, from the teachings herein. Furthermore, as described above, fewer than the expected number of sample counts could be used, such as when it is sufficient to detect merely a portion of the respective preamble. For example, for a Miller (TRext=1, M=8) encoded data has a Z value of 348 sign changes. However, in an embodiment, a portion of the preamble may be detected by use of a sequence of counts less than 348, such as 32 sample counts, providing a fairly reliable indication that the entire preamble is being received.

In step 506, matched filtering of a sequence of counts of samples is performed to determine whether a preamble is detected. For example, the sequence of counts can be a number of Z sample counts, or less than Z sample counts. In the current example, match filtering can be performed on the sequence of sample counts 602a-602g. In an example embodiment, matched filtering is performed by comparing each sample count of the seven sample counts 6021-602g to a corresponding expected sample count for that time interval. If each sample count is within an expected range of variation from the expected sample count for that particular time interval, the input signal is matched and a preamble is detected. For example, a processor, a series of comparators, logic gates, or any other suitable logic/circuitry may be used to perform step 506.

Note that the time interval between the respective time points and a rate of sampling dictates an expected sample count. As shown in FIG. 6, the time interval between time points 322a and 322b is of length T, as is the time interval between time points 322d and 322e and between time points 322g and 322h. The time interval between time points 322b and 322c is of length T/2, as is the time interval between time points 322c and 322d and between time points 322e and 322f. The time interval between time points 322f and 322g is 3T/2. In the current example, for illustrative purposes, it is assumed that the expected number of samples over a time interval T is equal 64, and that an expected variation in T is +/− 15% (+/− 10 samples). For these parameters, Table 2 shows acceptable ranges for sample counts in the respective time intervals:

TABLE 2

| | | expected | |
|---|---|---|---|
| | | number of | expected range of |
| Time interval | length | samples | sample counts |
| time points 322a-322b | T | 64 | 54-74 |
| time points 322b-322c | T/2 | 32 | 27-37 |
| time points 322c-322d | T/2 | 32 | 27-37 |
| time points 322d-322e | T | 64 | 54-74 |
| time points 322e-322f | T/2 | 32 | 27-37 |
| time points 322f-322g | 3T/2 | 96 | 81-111 |
| time points 322g-322h | T | 64 | 54-74 |

Thus, in an embodiment, the matched filtering of step 506 determines whether each sample count of the sequence of Z sample counts (or fewer sample counts) is within a predetermined acceptable range (such as shown in column 4 of Table 2), and if so, a preamble is detected. If it is determined that a preamble is not detected in step 506, such as if one or more sample counts are not within the respective predetermined acceptable range, step 504 is repeated to produce a next sample count of additional samples received on the input signal. Step 506 is repeated using the next sample count and the previous Z-1 counts of samples to be the new sequence of Z counts used to determine whether a preamble is detected. Steps 504 and 506 can be repeated in this manner as many times as needed, until a preamble is detected or an expected time interval for preamble detection is ended.

In an embodiment, base-band portion 216 of FIG. 2A performs steps 502, 504, and 506. Detailed example embodiments for base-band portion 216, and further detail regarding the steps of flowchart 500 are described in further detail below.

Example System Embodiments

In embodiments, preamble detection systems can be configured to operate on one or more components of an input signal, such as I-phase and Q-phase components of an input signal. Thus, in an I/Q implementation, the I-phase and Q-phase components can both be processed in separate channels to detect the preamble of the input signal, and the results from one or both of the I-phase and Q-phase channels can be utilized as desired.

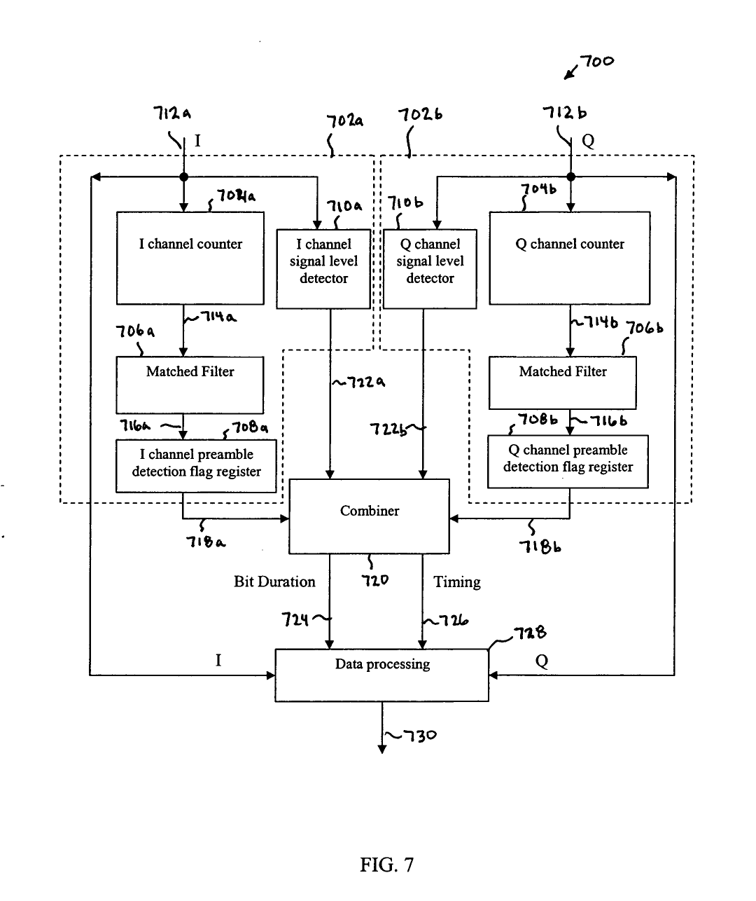

FIG. 7 shows an example preamble detection system 700 that can be implemented in the base-band portion of a receiver used in a wireless communication system, such as base-band portion 216. As shown in FIG. 7, system 700 includes an I-channel portion 702a and a Q-channel portion 702b. I-channel portion 702a includes a counter 704a, a matched filter 706a, a preamble detection flag register 708a, and a signal level detector 710a. Q-channel portion 702b includes a counter 704b, a matched filter 706b, a preamble detection flag register 708b, and a signal level detector 710b.

I-channel portion 702a of system 700 is described in detail as follows. I-channel portion 702a receives an in-phase signal component 712a of an input signal. It is noted that elements of Q-channel portion 702b are generally similar to similarly numbered elements of I-channel portion 702a, and thus may not be described in as much detail herein for the sake of brevity. Q-channel portion 702b receives a quadrature-phase signal component 712b of the input signal. In-phase signal component 712a and quadrature signal component 712b respectively include an I-phase and a Q-phase stream of signal samples of a demodulated input signal.

In-phase signal component 712a is received by counter 704a. In an embodiment, counter 704a performs step 504 of flowchart 500, shown in FIG. 5. Counter 704a counts samples received in in-phase signal component 712a, between sign changes (i.e, change from positive to negative sign, change from negative to positive sign). In other words, each time a sign change is received, counter 704a outputs a completed sample count on signal 714a for a previous time interval, and. begins counting a new sample count for a new time interval. Thus, counter 704a generates a sequence of sample counts on signal 714a. Counter 704b performs a similar function for Q-channel portion 702b, outputting a sequence of sample counts on signal 714b. As described above, the sequence of sample counts can have a length of Z or less, depending on the application, where Z is a number of sign changes expected in a preamble being detected.

If a preamble signal is not being received, the sequence of sample counts include sample counts that are random numbers without deterministic components. However, if a preamble signal is received, sample counts of the sequence have deterministic components reflecting real preamble waveforms. For example, with respect to FIG. 6, for a FM0 (TRext=0) preamble, seven zero-crossings are expected, with the following time intervals between zero-crossing: T, T/2, T/2, T, T/2, 3T/2, T, where T is equal to a bit duration (cycle period). Therefore, if the number of samples within T is equal to 64, then the Z sample counts on signals 704a and 704b will ideally be 64, 32, 32, 64, 32, 96, 64, as shown in FIG. 6. (Note that in embodiments, the number of samples between zero-crossing are used, not the values of the samples themselves.)

As shown in FIG. 7, matched filter 706a receives signal 714a, and thus receives the sequence of sample counts sequentially from counter 704a. In an embodiment, matched filter 706a performs step 506 of flowchart 500 shown in FIG. 5. Matched filter 706a performs a matched filtering function on the sequence of Z sample counts received on signal 714a. If matched filter 706a determines a match for the Z sample counts, a preamble is detected for I-channel portion 702a. Matched filter 706b performs a similar function for Q-channel portion 702b, determining whether there is a match for the sequence of Z sample counts on signal 714b. If matched filter 706b determines a match for the Z sample counts, a preamble is detected for Q-channel portion 702b.

In an alternative embodiment, where a portion of a preamble is to be detected, matched filters 706a and 706b may operate on sequences of sample counts having numbers less than Z. Thus, in embodiments, matched filters 706a and 706b may operate on sequences of N sample counts, where N is equal or less than Z.

Register 708a receives an indication signal 716a from matched filter 706a, which indicates whether a preamble is detected for I-channel portion 702a. In an embodiment, register 708a stores the indication as a flag indicating whether the preamble is detected. Register 708a outputs an I-channel preamble indication signal 718a, which includes the value of the flag. Similarly, register 708b receives an indication signal 716b from matched filter 706b, which indicates whether a preamble is detected for Q-channel portion 702b. In an embodiment, register 708b stores the indication as a flag indicating whether the preamble is detected. Register 708b outputs a Q-channel preamble indication signal 718b, which includes the value of the flag.

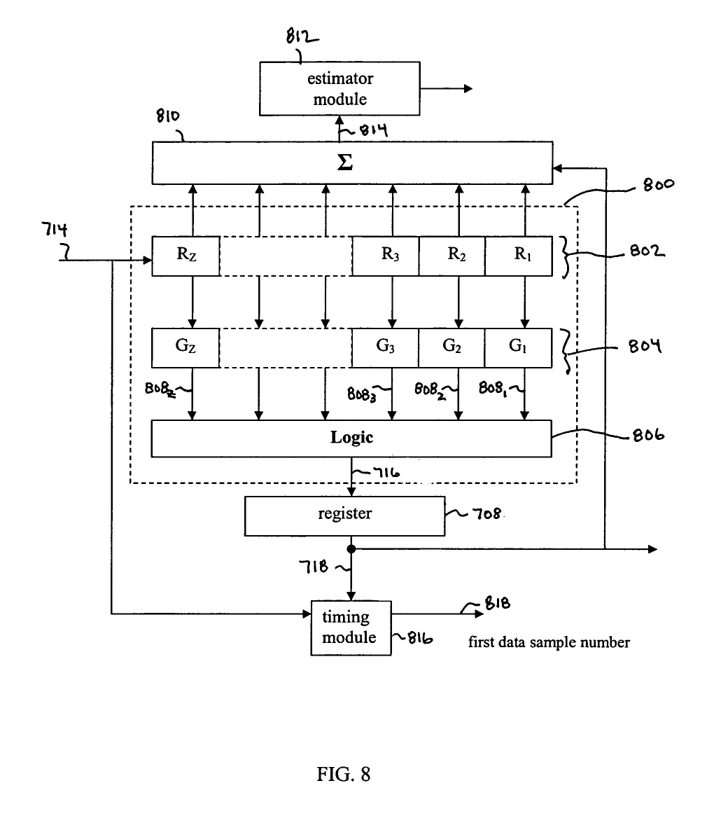

An example embodiment for matched filters 706a and 706b is described with respect to FIG. 8. FIG. 8 shows an example block diagram of a gate-type matched filter 800, according to an embodiment of the present invention. As shown in FIG. 8, matched filter 800 includes a shift register 802, a series of gates 804, and a logic 806.

The Z (or fewer) sample counts of signal 714 (which can be signal 714a or 714b when matched filter 800 is implemented in the respective I- or Q-channel portion 702a and 702b) are received at an input register R_{z} of shift register 802. Shift register 802 includes Z registers R_{z}-R₁ that are coupled in series. Each register of shift register 802 receives as input the output of the previous register. The output of the last register R₁ is shifted out of shift register 802. Thus, sample counts of signal 714 are shifted through registers R_{z}-R₁ such that each of registers R_{z}-R₁ stores a respective sample count.

In an alternative embodiment, where a portion of a preamble is to be detected, shift register 802 may have fewer than Z registers R. Thus, in embodiments, shift register 802 may have N registers, where N is equal or less than Z.

The sample counts stored in registers R_{z}-R₁ are each provided as input to a corresponding one of gates G_{z}-G₁, which form series of gates 804. For example, for detection of preamble 302 shown in FIG. 6, Z is equal to 7, and thus seven registers R and seven gates G may be present. Registers R_{z}-R₁ may store sample counts 602a-602g, respectively, for example. Each of gates G_{z}-G₁ has a range of sample counts that are acceptable for the particular preamble being detected. Each of the Z sample counts of registers R_{z}-R₁ is evaluated by the corresponding gate to determine whether is within the range of the gate. Gates G_{z}-G₁ each output a respective indication signal 808_{z}-808₁ indicating whether the respective sample count is within the range of the gate. For example, a gate may output a logic “1” if the current sample count is within the range, and a logic “0” if the current sample count is not within the range. Alternatively, the logic values for the respective indications may be reversed.

The ranges of each of gates GZ-G1 are typically stored in memory/storage or otherwise. Furthermore, the ranges may be adapted or varied, depending on a desired tolerance for errors, the type of preamble to be detected, etc. Furthermore, in an alternative embodiment where shift register 802 requires fewer than Z registers, fewer than Z gates G may be present.

Thus, in embodiments, there may be N gates present, where N is equal or less than Z.

Indication signals 808_{z}-808₁ are coupled to logic 806. Logic 806 processes indication signals 808_{z}-808₁ to determine whether a preamble is detected for the current Z sample counts. For example, logic 806 may include a logic AND gate that receives indication signals 808_{z}-808₁ as input. If all of indication signals 808_{z}-808₁ indicate that their respective sample count is in range (e.g., each of indication signals 808_{z}-808₁=logic “1”), the logic AND gate outputs a logic “1” signal, determining that a preamble is detected.

As shown in FIG. 8, logic 806 outputs indication signal 716, which is stored by register 708.

In an embodiment, a summer 810 and an estimator module 812 may be optionally present. Summer 810 and estimator module 812 may be used to determine a number of samples that will occur during a bit interval for data subsequent to a detected preamble, if the current sampling rate is used. If a preamble has been detected, as indicated by preamble indication signal 718, summer 810 sums the sample count contents of registers R_{z}-R₁ and outputs a sum 814. Estimator module 812 receives sum 814 and determines a number of samples in a symbol interval. For example, in an embodiment, estimator module 812 divides the summed sample count of sum 814 by a number of symbols in the preamble. For example, referring to FIG. 6, the number of symbols in preamble 302 is equal to 6 (i.e., preamble 302 includes six symbol intervals 324). Summer 814 sums sample counts 6021-602g for a total of 384 samples. Estimator module 812 divides the summed sample count (384) by the number of symbols (6) in preamble 302 to determine a number of 384/6=64 samples per symbol/bit interval. This information may be used by subsequent data processing in the receiver.

Note that detection of a preamble allows a receiver to indicate the beginning of data transmission following the preamble—an index of the first sample of the first data symbol. Initialization of data synchronization (timing) can be based on the assumption that the first sample after the preamble is detected is the first data sample. Thus, a timing module 816 may be optionally present to provide synchronization based on detection of a preamble. Timing module 816 receives signal 714 and preamble indication signal 718, and outputs a data synchronization signal 818, that includes information regarding a position of the first data symbol.

Timing can be also initialized based on some specific features of a preamble. For example, in the case of FM0 encoded data, an estimate of timing position can be based on the unique “violation” symbol, having a duration equal to one and a half of the cycle (3T/2) as shown in FIG. 6. A sample index corresponding to a maximum number of samples, exceeding the lower bound of the widest gate, is the end of the “violation” symbol in the preamble.

Note that in the embodiment of FIG. 7, having both I- and Q-channel processing, preamble detection, estimation of the symbol duration (symbol rate), and data timing initialization can be independently performed for both I and Q components. A final result of the preamble detection may be some combination of I and Q processing, performed by a combiner 720. Combiner 720 processes and/or combines this information, and outputs a bit duration signal 724 and/or a timing initialization signal 726.

A data processing 728 is present in a receiver to process the data subsequent to the detected preamble. In the embodiment of FIG. 7, data processing 728 receives in-phase signal component 712a, Q-phase signal component 712b, bit duration signal 724 and timing initialization signal 726, and accordingly processes data received on the input signal subsequent to the detected preamble. Data processing 728 outputs a data signal 730.

In an embodiment, combiner 720 receives estimates of data rate (bit duration) and timing from one of the I-channel or Q-channel, or from both of the I- and Q-channels if a preamble has been detected in both channels. Furthermore, in an embodiment, combiner 720 receives signal level indications 722a and 722b from I-channel signal level detector 710a and Q-channel signal level detector 710b, respectively, as shown in FIG. 7. Signal level indications 722a and 722b provide indications of signal levels and/or signal-to-noise ratios of signals received in the I and Q channels. Combiner 720 can use these signal level indications to combine the preamble detection results, symbol duration results, and/or data timing results provided by I and Q channel portions 702a and 702b, as desired.

For example, if a preamble has been detected only in one of I and Q channel portions 702a and 702b, data processing uses estimates from the particular channel.

If the preamble has been detected in both the I and Q channels, combiner 720 can combine the information from both channels in various ways. For example, combiner 720 may utilize preamble and other information only or largely from the channel having the higher signal level, as indicated by signal level indications 722a and 722b. In another embodiment, combiner 720 may perform an averaging of the data received from the two channels, including a weighted averaging based on the relative channel signal strengths.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for detecting a preamble portion of a signal, comprising:
(a) receiving a plurality of samples in an input signal;
(b) counting samples that occur between consecutive sign changes in the received plurality of samples;
(c) performing step (b) a number of times to produce a sequence of counts of samples between consecutive sign changes in the received plurality of samples; and
(d) performing matched filtering of the sequence of counts of samples to determine whether a preamble is detected.

2. The method of claim 1, wherein the input signal comprises FM0 encoded data and a number Z of sign changes for an expected FM0 preamble is selected to be a value equal to 7 or 31, wherein step (c) comprises:
performing step (b) the selected value of Z times.

3. The method of claim 1, wherein the input signal comprises Miller encoded data and a number Z of sign changes for an expected Miller preamble is selected to be a value equal to 36, 76, 84, 156, 172, or 348, wherein step (c) comprises:
performing step (b) the selected value of Z times.

4. The method of claim 1, wherein the sequence of sample counts has a length of N sample counts, and if it is determined that a preamble is not detected in step (d):
(e) repeating step (b) to produce an additional count of samples between a last sign change and a next sign change in the received plurality of samples; and
(f) repeating step (d) using the additional count of samples and the previous N-1 counts of samples as the sequence of N sample counts to determine whether a preamble is detected.

5. The method of claim 1, wherein if it is determined that a preamble is not detected in step (f):
repeating steps (e) and (f) until a preamble is detected or an expected time interval for preamble detection is ended.

6. The method of claim 1, further comprising:
(e) estimating a data rate and a timing for data decoding if a preamble is detected.

7. A method for detecting a preamble portion of a signal, comprising:
(a) receiving an in-phase signal component of an input signal having a first plurality of samples;
(b) counting samples that occur between consecutive sign changes in the received first plurality of samples;
(c) performing step (b) a number N of times to produce a first sequence of counts of samples between consecutive sign changes in the received first plurality of samples;
(d) performing matched filtering of the first sequence of counts of samples to generate a first preamble detection indication for the in-phase signal component;
(e) receiving a quadrature-phase signal component of the input signal having a second plurality of samples;
(f) counting samples that occur between consecutive sign changes in the received second plurality of samples;
(g) performing step (f) the number N of times to produce a second sequence of counts of samples between consecutive sign changes in the received second plurality of samples; and
(h) performing matched filtering of the second sequence of N counts of samples to generate a second preamble detection indication for the quadrature-phase signal component.

8. The method of claim 7, further comprising:
(i) processing the first and second preamble detection indications to determine whether a preamble is detected for the input signal.

9. The method of claim 8, wherein step (i) comprises:
performing a logical OR function of the first and second preamble detection indications to determine whether a preamble is detected for the input signal.

10. The method of claim 8, further comprising:
(j) selecting at least one of the in-phase signal component and quadrature-phase signal component for further processing based on the first and second preamble detection indications.

11. The method of claim 8, further comprising:
(j) using an estimate of a data rate and a timing from the in-phase signal component for data decoding if the first preamble detection indication indicates that a preamble is detected.

12. The method of claim 8, further comprising:
(j) using an estimate of a data rate and a timing from the quadrature-phase signal component for data decoding if the second preamble detection indication indicates that a preamble is detected.

13. The method of claim 8, further comprising:
(j) receiving an estimate of a first data rate and a first timing from the in-phase signal component;
(k) receiving an estimate of a second data rate and a second timing from the quadrature-phase signal component;
(l) combining the first data rate and the second data rate to determine a data rate for data decoding; and
(m) combining the first timing and the second timing to determine timing for data decoding.

14. The method of claim 7, further comprising:
(i) determining whether the in-phase signal component or the quadrature-phase signal component has a higher signal level; and
(j) using the one of the in-phase signal component or the quadrature-phase signal component having the higher signal level for estimation of bit rate and timing for data decoding.

15. The method of claim 7, further comprising:
(i) if a preamble is detected, indicating a start of data at a first sample following the detected preamble.

16. The method of claim 8, further comprising:
(j) initializing data symbol timing based on a characteristic of a detected preamble.

17. A system in a receiver for detecting a preamble portion of a signal, comprising:
a counter that counts samples that occur between consecutive sign changes in a plurality of samples received on an input signal;
a matched filter that includes a shift register of N registers, wherein an input register of the shift registers is coupled to an output of the counter, wherein the N registers store a sequence of N sample counts received from the counter;
N gates that are coupled to the N registers, wherein each gate of the N gates determines whether a sample count of a corresponding register of the N registers is within a predetermined range; and
a logical AND that receives an output determination signal from each gate and generates a preamble detection indication.

18. The system of claim 17, further comprising:
an estimator that estimates a number of samples in a symbol interval based on the N samples counts and a number of symbols in a detected preamble.

19. The system of claim 18, wherein the estimator comprises:
a summer that sums the N sample counts stored in the N registers; and
a divider that divides the summed sample count by the number of symbols in the preamble to generate the estimate of the number of samples in a symbol interval.

20. The system of claim 17, further comprising:
a timing module that receives the preamble detection indication and the output of the counter, and determines a first sample of a first data symbol following a detected preamble.

21. The system of claim 17, wherein the receiver is included in a radio frequency identification (RFID) reader.

22. The system of claim 17, wherein N≦a number of sign changes in an expected preamble.

23. A system in a receiver for detecting a preamble portion of a signal, comprising:
a first counter that counts samples that occur between consecutive sign changes in a plurality of samples received on an in-phase signal component of an input signal;
a first matched filter that includes a first shift register having N registers, wherein an input register of the first shift register is coupled to an output of the first counter, wherein the N registers of the first shift register store a first sequence of N samples counts received from the first counter;
a first N gates that are coupled to the N registers of the first shift register, wherein each gate of the first N gates determines whether a sample count of a corresponding register of the N registers of the first shift register is within a predetermined range;
a first logical AND that receives a determination signal from each gate of the first N gates and generates a first preamble detection indication;
a second counter that counts samples that occur between consecutive sign changes in a plurality of samples received on an quadrature-phase signal component of the input signal;
a second matched filter that includes a second shift register having N registers, wherein an input register of the second shift register is coupled to an output of the second counter, wherein the N registers of the second shift register store a second sequence of N samples counts received from the second counter;
a second N gates that are coupled to the N registers of the second shift register, wherein each gate of the second N gates determines whether a sample count of a corresponding register of the N registers of the second shift register is within a predetermined range; and
a second logical AND that receives a determination signal from each gate of the second N gates and generates a second preamble detection indication.

24. The system of claim 23, further comprising:
a first estimator that generates a first estimation of a number of samples in a symbol interval based on the N samples counts stored in the first shift register and a number of symbols of a preamble; and
a second estimator that generates a second estimation of a number of samples in a symbol interval based on the N samples counts stored in the second shift register and a number of symbols of the preamble.

25. The system of claim 24, further comprising:
a first timing module that receives the first preamble detection indication and the output of the first counter, and generates a first determination of a first sample of a first data symbol following a detected preamble; and
a second timing module that receives the second preamble detection indication and the output of the second counter, and generates a second determination of the first sample of the first data symbol following the detected preamble.

26. The system of claim 25, further comprising:
a combiner that receives the first and second preamble detection indications, the first and second estimations, and the first and second determinations of the first sample, and initializes data symbol timing and determines a data symbol duration.

27. The system of claim 23, wherein the receiver is included in a radio frequency identification (RFID) reader.

28. The system of claim 23, wherein N≦a number of sign changes in an expected preamble.
